(19) United States
(12) Patent Application Publication
(10) Pub. No.: US 2022/0079729 A1
(43) Pub. Date: Mar. 17, 2022

(54) FAUCET-TO-ORAL LIQUID FLOSSING SYSTEM AND METHOD OF USE

(71) Applicant: James R. Klauder, Fernandina Beach, FL (US)

(72) Inventor: James R. Klauder, Fernandina Beach, FL (US)

(21) Appl. No.: 16/830,658

(22) Filed: Mar. 26, 2020

Related U.S. Application Data
(63) Continuation-in-part of application No. 16/744,051, now abandoned.

(51) Int. Cl. A61C 17/032; A61C 17/024; A61C 15/00

(52) U.S. Cl. CPC A61C 17/032; A61C 15/00; A61C 17/024

(57) ABSTRACT

A faucet-to-oral liquid flossing system allows a person to quickly connect a nozzle to a bathroom or another faucet to direct the water from it to their mouth. The system uses a hose and an elastic connector to attach to the faucet. The nozzle has a switch to control the release of the water into the mouth.

### BACKGROUND

### 1. Field of the Invention

The present invention relates generally to dental hygiene systems, and more specifically, to a faucet-to-oral liquid flossing system that rapidly attaches to any faucet or pressurized water source to create a focused fluid flow for the removal of foreign objects from the mouth and gums.

### 2. Description of Related Art

Dental hygiene systems are well known in the art and are effective means to clean the mouth and correct disease therein. Commonly, flossing is done to remove debris from between the teeth where a brush or a mouthwash will not reach or have force enough to remove the debris there. For example, a thread or string is suspended tightly between the fingers and is pressed down between the teeth and moved back and forth to rub against the teeth and dislodge any debris there. This process is repeated for each space between pairs of teeth.

One of the problems commonly associated with common dental hygiene systems is its limited efficiency. For example, the thread that is passed between the teeth commonly breaks and must be removed either by a new thread or another tool. This removal process takes time, effort and material. Additionally, the ability of the thread or string to reach each place is limited to the movement thereof by the person. The result is material that is missed.

Accordingly, although great strides have been made in the area of dental hygiene systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are side views of a faucet-to-oral liquid flossing system in accordance with a preferred embodiment of the present application;

FIG. 2 is a diagram of an alternative embodiment of the system of FIGS. 1A and 1B;

FIG. 3 is a side view of an alternative embodiment of the system of FIGS. 1A and 1b; and

FIG. 4 is a method of removing foreign objects from the mouth and the general cleaning thereof.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional dental hygiene systems. Specifically, the present invention provides means of applying a pressurized fluid flow that is directed at the teeth and the spaces therebetween. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

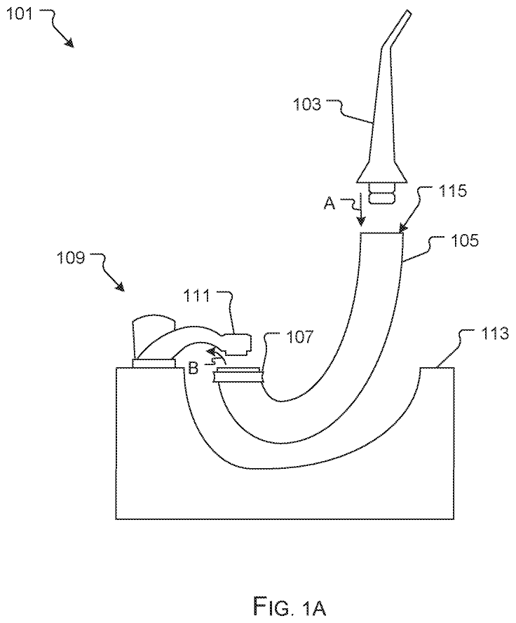

Referring now to the drawings wherein like reference characters identify corresponding or similar elements throughout the several views, FIGS. 1A and 1B depict a side views of a faucet-to-oral liquid flossing system in accordance with a preferred embodiment of the present application. It will be appreciated that system 101 overcomes one or more of the above-listed problems commonly associated with conventional dental hygiene systems.

In the contemplated embodiment, system 101 includes a nozzle 103 in fluid communication with a hose 105. The hose 105 is removably attached to a faucet 109 by a deformable band 107 that is configured to hold the hose 105 around the aperture 111 of the faucet 109. The faucet 111 normally discharges in a sink 113 and it is contemplated that the water from the faucet 111 once released into the mouth of a user is disposed of in the sink 113.

In use, the nozzle 103 is inserted into a first end 115 of the hose 105 as depicted by motion A. The other end of the hose 105 is secured to the faucet 109 via deformable band 107 as depicted by motion B. Water from the faucet 109 is then directed to the nozzle 103 via the hose 105 where it is forced through spaces between the teeth or against the teeth to remove material. The water is then released to the sink 113.

It should be appreciated that one of the unique features believed characteristic of the present application is that the deformable band 107 allows the system 101 to be attached at any faucet 109 to allow a person to clean their mouth at home or while away. It will be appreciated that the whole of the system 101 is lightweight and compact this improves the ability of the system to travel.

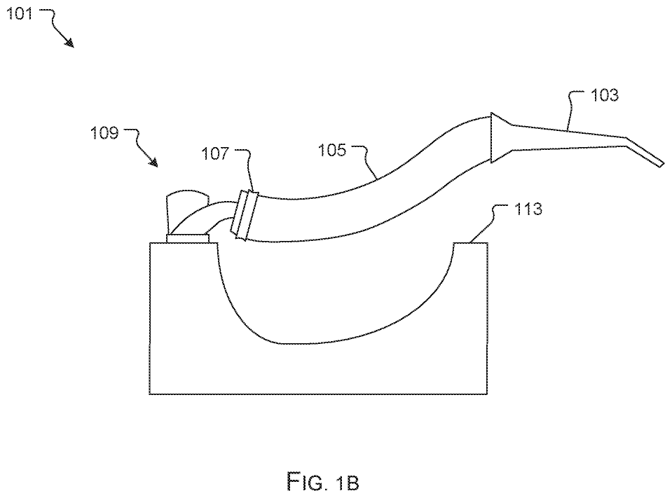

Referring now to FIG. 2 an alternative embodiment of system 101 is depicted. In the embodiment 201, the nozzle 103 includes an activation device 203 to control the flow of water from the nozzle 103. The hose 105 is attached to the faucet 109 via a self-restricting band 205. It is contemplated that this system 201 improves the operation of the nozzle 103 and facilitates the attachment of the hose 105 to the faucet 109.

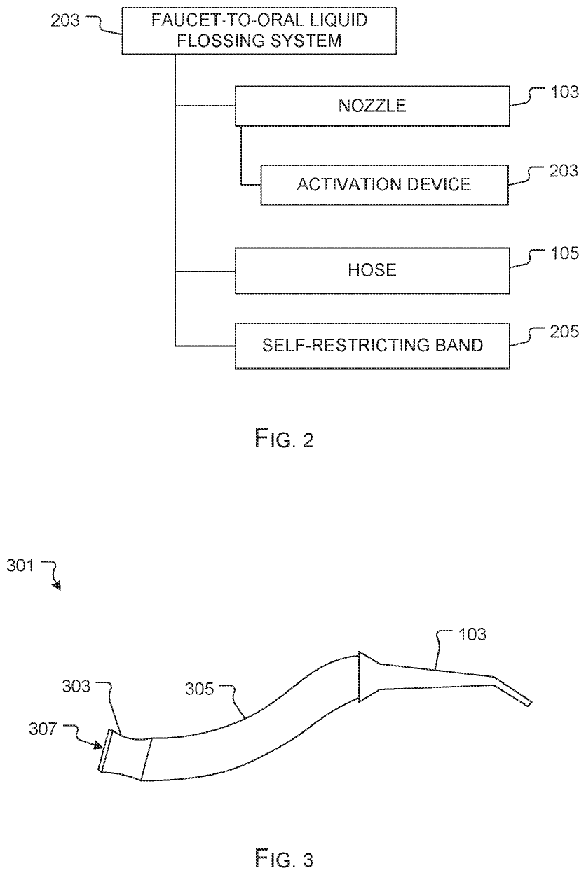

As depicted by FIG. 3 another alternative embodiment 301 includes an elastic zone 303 that integrates the deformable band 107 or self-restricting band 205 in the far end 307 of the hose 305. It is contemplated that this further simplifies the connection between the hose 305 and the faucet 109.

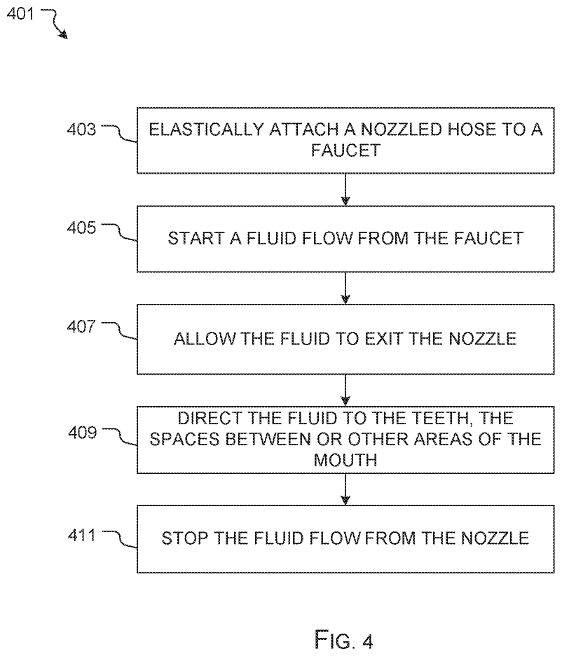

Referring now to FIG. 4 a method of removing foreign objects from a mouth or the cleaning thereof. Method 401 includes elastically attaching a nozzled hose to a faucet 403, starting a fluid flow from the faucet 405, allowing the fluid to exit the nozzle 407, directing the fluid to the teeth, the spaces between or other areas of the mouth 409 and stopping the fluid flow from the nozzle 411.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A faucet-to-oral liquid flossing system comprising:
a hose with a nozzle at a first end and a deformable band at the other end;
the deformable band configured to place the nozzle in fluid communication with a faucet via the hose;
wherein the hose is removably attachable to the faucet; and
wherein the nozzle creates a pressurized fluid flow that is directed to the mouth or teeth of a user.

2. The system of claim 1 wherein the deformable band is able to self-restrict.

3. A faucet-to-oral liquid flossing system comprising a hose with one end having an integral elastic zone at one end thereof wherein the hose is used to direct a fluid to a nozzle.

4. A method of removing foreign material from a mouth comprising:
elastically attaching a nozzled hose to a faucet;
starting a fluid flow from the faucet;
allowing the fluid to exit the nozzle;
directing the fluid to the teeth, the spaces between or other areas of the mouth; and
stopping the fluid flow from the nozzle.
